(19) United States
(12) Patent Application Publication
(10) Pub. No.: US 2008/0288516 A1
(43) Pub. Date: Nov. 20, 2008

(54) UNIVERSAL MEME IDENTIFICATION

(76) Inventor: Marc C. Hadfield, New York, NY (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 12/122,591

(22) Filed: May 16, 2008

Related U.S. Application Data
(60) Provisional application No. 60/930,794, filed on May 17, 2007.

(51) Int. Cl. G06F 17/30

(52) U.S. Cl. 707/100; 707/E17.045

(57) ABSTRACT

Methods and apparatus, including computer program products, related to universal meme identification. In general, unique identifiers may be associated with semantic concepts that are part of a semantic network. The semantic networks may be implemented in a computer-implemented data structure that may be queried based on a unique identifier of semantic concepts in the semantic network. A schema may be used to define a format of unique identifiers for semantic concepts, where that schema may dictate that the unique identifiers are to include includes data identifying an authority, data identifying an entity of the authority having permission to issue global unique identifiers, data identifying a grouping of global unique identifiers, and data identifying a unit of information in the grouping of global unique identifiers.

### CROSS REFERENCE TO RELATED APPLICATIONS

This application claims the benefit of U.S. Provisional Patent Application entitled “UNIVERSAL MEME IDENTIFICATION SYSTEM AND METHOD”, filed May 17, 2007, Application Ser. No. 60/930,794, the contents of which are hereby fully incorporated by reference.

### BACKGROUND

This disclosure relates generally to search systems, and more particularly to universal meme identification.

A meme may be a basic element of cultural inheritance, such as an abstract replicatory unit of information that is passed on from one human generation to another, much like a gene is the basic element of biological inheritance. General examples of memes include descriptive information about physical things, ideas, beliefs, values, and concepts.

### SUMMARY

This document includes discussions of systems and methods that use a definition of unique identifiers to be associated with semantic concepts containing authoritative information.

In one aspect, a system is disclosed for associating unique identifiers with semantic concepts that are part of a semantic network.

In related aspects, a system and method are disclosed for retrieving one or more information records over the Internet or an Intranet associated with semantic concepts using one or more such identifiers and/or additional criteria, and for embedding such identifiers in documents published on the Internet or an Intranet.

In a related aspect, a request for information derived from a unit of information that is associated with a global unique identifier is received, a lookup for the unit of information in a semantic network is performed, and data characterizing the unit of information is returned. The unit of information has a set of relationships with other units of information that have their own relationships. The relationships of the unit of information in combination with information about the unit of information uniquely identifies the unit of information within a namespace of units of information. The request may include a unique identifier to uniquely identify the unit of information.

In a related aspect, a request for assignment of a unit of information to a global unique identifier is received, the global unique identifier is generated, and an association of the unit of information and the global unique identifier is generated. The global unique identifier may include data identifying an authority, data identifying an entity having permission by the authority to issue global unique identifiers, data identifying a grouping of global unique identifiers, and data identifying the unit of information in the grouping of global unique identifiers.

In a related aspect, a database includes a semantic network and global unique identifiers associated with units of information in the semantic network. The semantic network is defined by units of information and their relationships with other units of information.

In a related aspect, associations of global unique identifiers and semantic concepts of a semantic network are included in a data structure. The associations have a one to one cardinality between the global unique identifiers and the semantic concepts, where the associations may identify locations of data representing the semantic concepts based on global unique identifiers, and the global unique identifiers may be globally unique within the semantic network.

In a related aspect, an electronic document includes a global unique identifier of a semantic concept of a semantic network, where the semantic concept is represented by a unit of information. The global unique identifier includes data identifying an authority, data identifying an entity having permission by the authority to issue global unique identifiers, data identifying a grouping of units of information in the semantic network, and data identifying the unit of information in the grouping.

The subject matter may be implemented as, for example, computer program products (e.g., as source code or compiled code tangibly embodied in computer-readable storage media), computer-implemented methods, and systems.

Implementations may include one or more of the following features.

Global unique identifiers may be used to query a semantic network.

Performing a lookup may include generating a network request based on the unique identifier.

Generating a network request may include generating a uniform resource locator based on the unique identifier.

A semantic network may be a directed graph consisting of vertices, which represent concepts, and edges, which represent semantic relations between the concepts.

A unit of information may be a meme.

A global unique identifier may include data identifying an authority, data identifying an entity having permission by the authority to issue global unique identifiers, data identifying a grouping of global unique identifiers, and data identifying the unit of information in the grouping of global unique identifiers. Components of a global unique identifier may be in an order from a first component to a last component of the data identifying the authority, the data identifying the entity having permission by the authority, the data identifying the grouping of units of information, and the data identifying the unit of information. Global unique identifiers may be globally unique across semantic networks.

Information about a unit of information may be a name of the unit of information.

A semantic network may be represented in a database having records, where each record includes fields characterizing one or more relationships among units of information in the semantic network.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a semantic network.

FIG. 2 includes a meme identification system and illustrates use of a definition of unique identifiers associated with semantic concepts to request information records.

FIG. 3 depicts a semantic network.

FIG. 4 depicts a semantic network with semantic concept identifiers and information records.

FIG. 5 illustrates a meme identification system.

FIG. 6 illustrates a meme identification system.

FIG. 7 includes a flowchart of a process to generate global unique identifiers.

FIG. 8 includes a flowchart of a process to retrieve information about memes.

Like reference symbols in the various drawings indicate like elements.

### DETAILED DESCRIPTION

This document describes systems and methods that use a definition of unique identifiers to be associated with semantic concepts. A semantic concept may be any concept which may be held in a person's mind that contains meaning, including physical things (both instances and classes), abstract concepts, events, or configurations of other semantic concepts. As such, a semantic concept may be described as containing authoritative information. Memes may be represented as semantic concepts in one or more semantic networks. A meme may be described as a unit of information (e.g., a semantic concept) having a set of relationships with other units of information (e.g., other semantic concepts) that have their own relationships and the relationships of the unit of information in combination with information about the unit of information may uniquely identify the unit of information. A meme may be generated, maintained, or both by one or more communities of thinkers.

In implementations, a system, method, or both may associate unique identifiers with semantic concepts that are part of a semantic network. A semantic network may be a set of semantic concepts which have defined relations among them. A system and method are described that may retrieve one or more information records over the Internet or an Intranet associated with semantic concepts, using one or more such identifiers and/or additional criteria, including general criteria, and for embedding such identifiers in documents published on the Internet or Intranet.

An example of a semantic network may be represented as follows:

Commercial Company

Software Company is a type of Commercial Company

MICROSOFT is an instance of a Software Company

ORACLE is an instance of a Software Company

MICROSOFT is a competitor of ORACLE.

In that semantic network, the terms “Commercial Company”, “Software Company”, “MICROSOFT”, and ORACLE” are semantic concepts. Also, the terms “type of”, “competitor of”, and “instance of” are semantic concept relationships. And, a “class” of semantic concept is a semantic concept that defines a category. As an instance occurs in exactly one place in the (known) universe—as an example, different instances in a semantic network may be used to distinguish between “A FORD TAURUS” and “that FORD TAURUS”. A semantic concept identifier may be a globally unique identifier assigned to a semantic concept. The identifier may be globally unique in the sense that within a semantic network (or, across semantic networks, in implementations) an instance is uniquely identified by a global unique identifier and the identifier does not correspond to more than one instance.

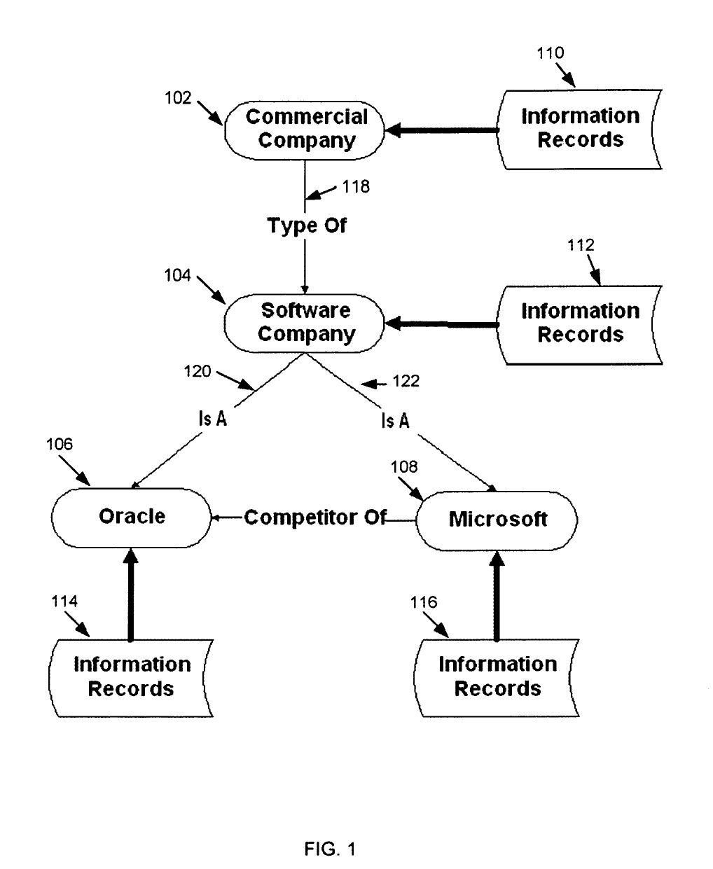

A semantic network may be maintained in a data structure, as illustrated in FIG. 1. This data structure may allow information records to be associated with each semantic concept. In particular, the semantic network of FIG. 1 includes the semantic concepts Commercial Company 102, Software Company 104, ORACLE 106, and MICROSOFT 108, each of which may have an associated one or more records (e.g., database records), as shown by the information records 110, 112, 114, 116, which may be a part of a same data structure (e.g., a same database table). To store the semantic network, those records may store a name of their respective semantic concept, their respective relationships, and other information. For example, if the data structure is a database, the first information records 110 may store a name Commercial Company to correspond to the semantic concept 102. Further, the information records 110 may include fields to represent a “Type Of” relationship 118, including a field indicating the concept has a “Type Of” relationship (which may include a direction of the relationship; e.g., a field indicating a “type of” relationship exists from the semantic concept Commercial Company to the semantic concept Software Company) and a corresponding field to indicate the relationship is with the semantic concept Software Company 104 (e.g., the field may include a global unique identifier for the information records 110). As another example, if the data structure is a database, the second information records 112 may include a field with the name Software Company; a combination of fields for the relationships “Type Of” 118, “Is A” 120, and “Is A” 122, which may include fields indicating the type of relationships and fields indicating semantic concepts related to the semantic concept 104 by those relationships.

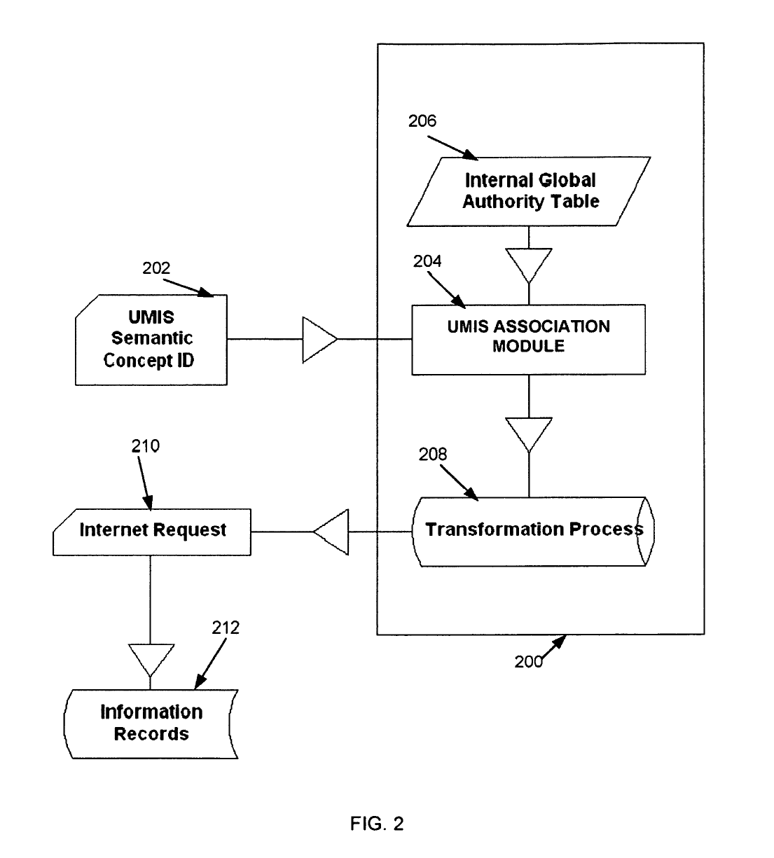

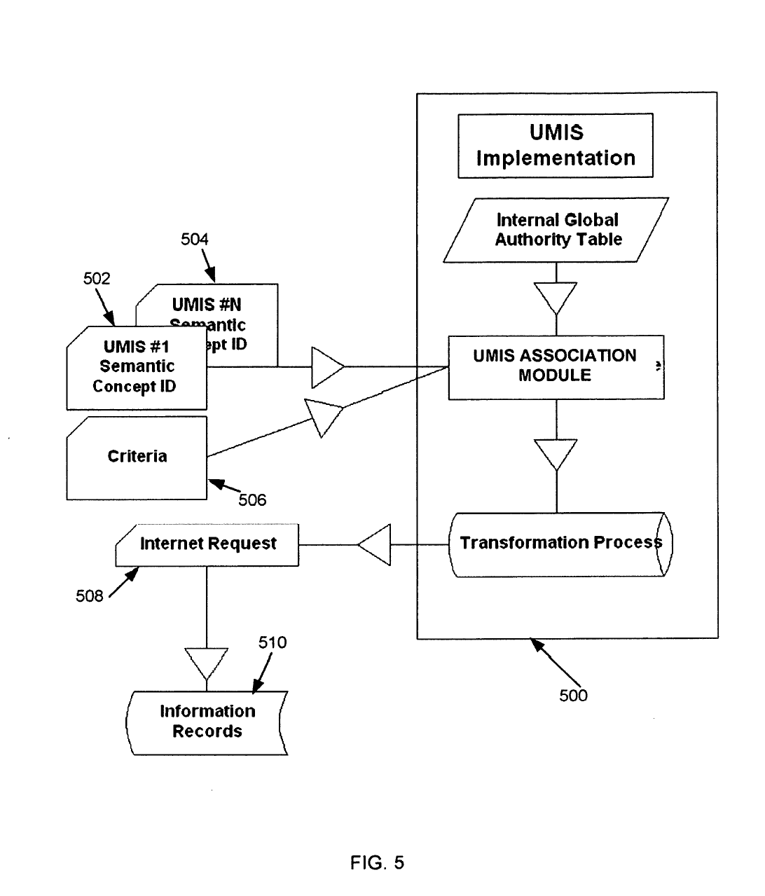

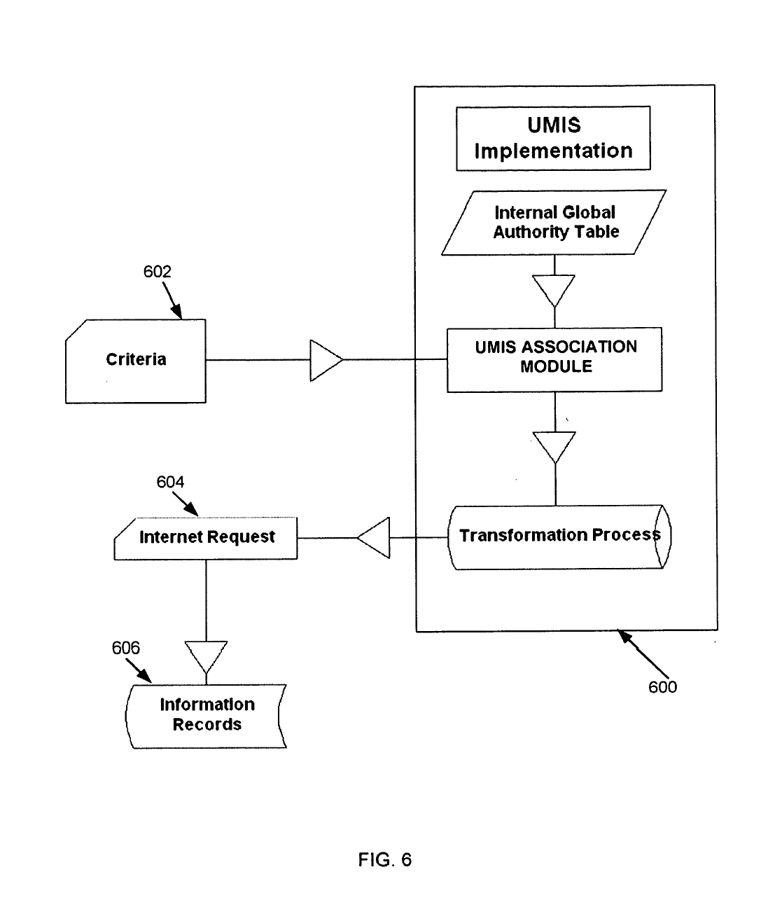

FIG. 2 includes a meme identification system 200 and illustrates use of a definition of unique identifiers associated with semantic concepts to request information records. The system 200 may be an example of what may be referred to as a Universal Meme Identification System (UMIS) system. The system 200 of FIG. 2 may be the same system as the systems 500, 600 of FIGS. 5 and 6 (e.g., the system 200 of FIG. 2 may perform the operations of all or some of the systems). The system 200 may assign unique identifiers to semantic concepts and may be a general solution to associate a unique identifier to a semantic concept (e.g., a semantic concept that is defined by information records external to the system 200) that contains information that authoritatively defines the semantic concept.

The unique identifiers used by the system 200 may include information concerning how to retrieve authoritative information regarding the semantic concept. A software module of the system 200 may use a semantic concept identifier and transform the information into an Internet request for information records, authoritatively defining the semantic concept with no further outside information. Specifically, the system 200 may use a semantic identifier 202 and implementation software 204, using no additional outside information, to retrieve authoritative information records concerning the semantic concept. The defining and the records may be authoritative in the sense that a semantic concept that represents a single, unique, instance may be individually identified through the defining and the records may include the sole definition of the semantic concept, though, in implementations records may only be authoritative for a specific semantic network (e.g., a same semantic concept may be defined once in each of two semantic networks).

Unique identifiers of semantic concepts, such as the semantic identifier 202, may follow an example schema of:

### <Global Authority>.<Issuer<#DigitalSignature>>.<NameSpace>.<Instance>

In that example schema, components are separated using an ASCII (American Standard Code for Information Interchange) period (‘.’). A first component, Global Authority, may be a mandatory component that identifies an authority from which issuance of concept identifiers may be made, and a global authority may manage issuers. Thus, as a business process, the global authority may be a “root” that manages the Issuers. The global authority may be “hard-coded” such that to meet the criteria of being a valid authority to manage issuance of global unique identifiers, a global authority component matches a predefined global authority identification on a predefined list of global authorities. The Global Authority component may be limited to including alphabetic characters (upper and lower case), decimal numbers, dashes (‘-’), and periods (‘.’) from the ASCII character set. The Global Authority may be an Internet domain name in reverse dotted format. The Global Authority may be drawn from a list defined by an administrator of the system 200, where the list may be maintained, for example, in the Internal Global Authority Table 206. As an example: Com.MEMOMICS may be the reverse dotted format of the domain name: MEMOMICS.com, which may be a Global Authority. A semantic concept identifier with a Global Authority field that is not on the list maintained by the administrator of the system may be considered invalid.

A second component, the Issuer, may identify an issuer of semantic concept identifiers that may be within the Global Authority. The second component may be a mandatory component that may be limited to alphabetic characters (upper and lower case), decimal numbers, and dashes (‘-’) from the ASCII character set. The Issuer may be a unique name assigned by the administrator of the system to the entity which generated the semantic concept identifier. Within the Issuer component may be a digital signature component, named DigitalSignature, which may be an optional component and may be limited to including of alphabetic characters (upper and lower case), decimal numbers, and dashes (‘-’) from the ASCII character set. If present, the DigitalSignature may be separated from the Issuer by, for example, using a hash symbol (“#”). The DigitalSignature, if present, may be used to identify a source of a semantic concept identifier, confirm the integrity of the semantic concept identifier, and provide for versioning of semantic concept identifiers.

A third component, the NameSpace, may identify a grouping of instances of semantic concepts and may be a mandatory component. The third component may be limited to featuring alphabetic characters (upper and lower case), decimal numbers, and dash (‘-’) from the ASCII character set. The NameSpace may be used to group semantic concept identifiers. Finally, the Instance may be a mandatory component made up of data encoded in the Unicode (version 5 or greater) format.

The following are examples of semantic concept identifiers and descriptions of their components:

Com.MEMOMICS.ALITORA#123.bio.abc987654

Global Authority Com.MEMOMICS

Issuer: ALITORA

DigitalSignature: 123

NameSpace: bio

Instance: abc987654

Ai.Net.Meme.Parseon.gene.tp53#9606

Global Authority Ai.Net.Meme

Issuer: Parseon

No DigitalSignature

NameSpace: gene

Instance: tp53#9606

A semantic concept may exist once in a semantic network or once across multiple semantic networks. For example, there may be multiple semantic networks, where each issuer may have a different semantic network, and two semantic networks may have a same semantic concept. In that example, each semantic concept may be uniquely identified with a semantic concept identifier in the format described above.

As mentioned above, the semantic identifiers may be generated by the system 200. The system 200 may generate the semantic identifiers as part of a process of assigning a semantic identifier to a semantic concept, which may occur when a semantic concept is to be added to a semantic network. The semantic identifiers may be generated automatically or manually. As an example of automatic generation, the UMIS association module 204 may receive a request to add a semantic concept to a semantic network; the UMIS association module 204 may use an internal global authority table 206 to determine whether an authority of the entity that made the request is an authorized authority to cause a semantic concept identifier to be generated; the UMIS association module 204 may cause a semantic identifier to be generated, which may include adding a name of an issuer that made the request, including a namespace name, and pseudo-randomly generating a unique instance identifier to be included in the semantic identifier; and an association of the semantic concept identifier and information about the semantic concept may be stored (e.g., in information records 212).

As mentioned above, the system 200 may use a definition of unique identifiers to be associated with semantic concepts to generate a request for information records. This use may include receiving the semantic concept identifier 202, having UMIS association module 204 determine a global authority to associate with the semantic concept identifier by performing a lookup in the internal global authority table 206 based on a global authority component of the semantic concept identifier 202, using the global authority information in combination with the semantic concept identifier to perform a transformation process 208, and causing an internet request 210 with a transformed semantic concept identifier, where the internet request 210 identifies information records 212 that define a semantic concept, from which information from the information records 212 may be returned. The transformation process 208 may involve a re-arrangement of components of a semantic concept identifier to form a URL, may involve selecting a protocol (e.g., HTTP (HyperText Transfer Protocol)), and the like. There may be more than one type of transformation that may be performed to semantic concept identifiers; thus, a determination may be made as to which transformation to perform to a semantic concept identifier. Determining a transformation to perform for the transformation process 208 may involve performing a lookup of a semantic concept identifier to determine an associated transformation mechanism, technique, or both. For example, each namespace (or issuer) may be associated with a different transformation techniques and a lookup in a table of namespaces (or issuers) and transformation techniques may be performed to determine an appropriate namespace (or issuer) for a particular semantic concept identifier, where the technique may be a particular URL pattern to use to map components of a semantic concept identifier to a URL to be generated.

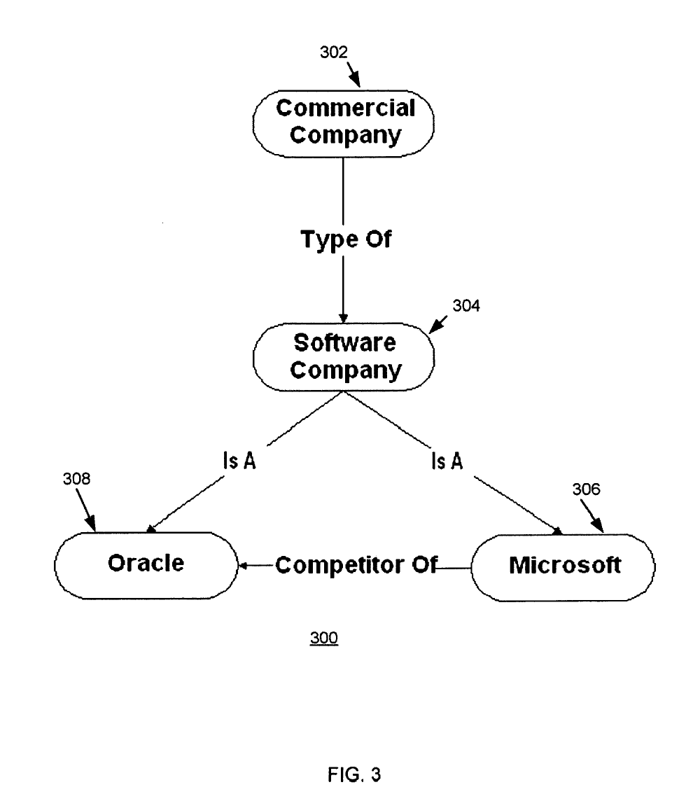

As mentioned above, unique identifiers may be associated semantic concepts that are part of a semantic network. In the semantic network 300 of FIG. 3, semantic concepts include: Commercial Company 302, Software Company 304, MICROSOFT 306, and ORACLE 308. Prior to or after any semantic concept is inserted into the data structure maintaining the semantic network, the semantic concept may be assigned exactly one semantic identifier to be associated with the semantic concept in the data structure. For example, the following is a list of the semantic concept identifiers and an assignment of semantic concepts to the semantic identifiers:

Commercial Company→Com.MEMOMICS.ALITORA.Company.1010

Software Company→Com.MEMOMICS.ALITORA.Company.1020

MICROSOFT→Com.MEMOMICS.ALITORA.Company.2001

ORACLE→Com.MEMOMICS.ALITORA.Company.2002

Thus, for example, the semantic concept identifier Com.MEMOMICS.ALITORA.Company.1010 may be assigned the semantic concept Commercial Company 302.

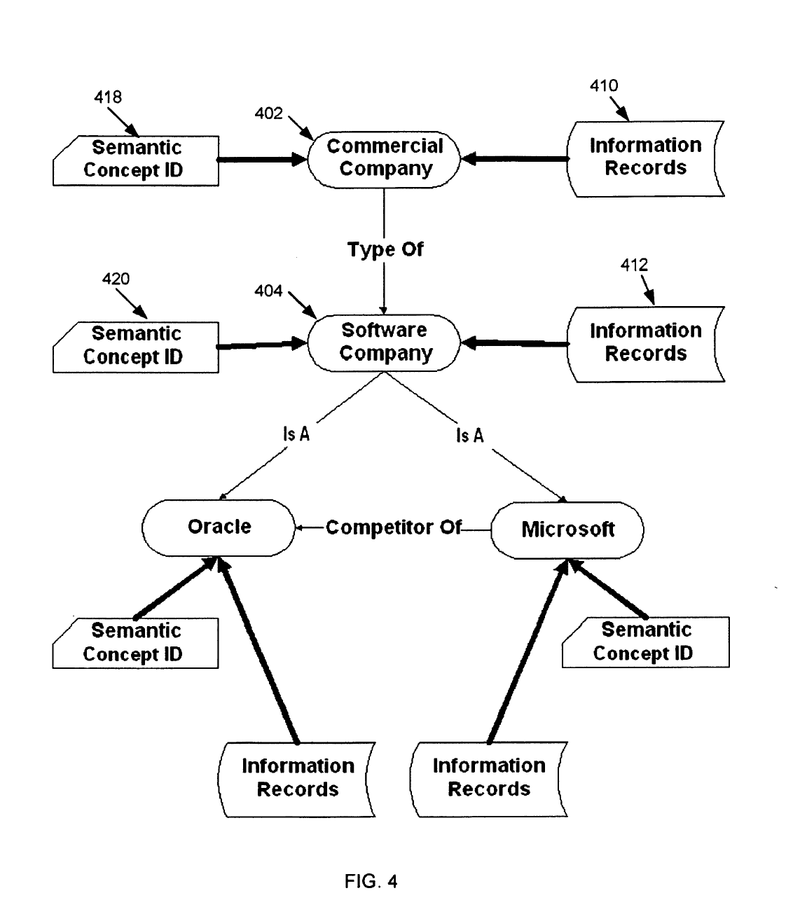

A semantic network data structure may allow for retrieval of information records associated with the semantic concept using the semantic identifier, as shown in FIG. 4. FIG. 4 depicts a semantic network with semantic concept identifiers and information records. For each semantic concept in the semantic network in FIG. 4 there is a corresponding semantic concept identifier and information records, where each semantic concept identifier uniquely identifies an associated semantic concept across one or more semantic networks (e.g., globally), and each set of one or more information records stores information about a semantic concept. As examples, the semantic concept Commercial Company 402 has a corresponding semantic concept identifier 418 and information about the semantic concept is stored in the information records 410, and, the semantic concept Software Company 404 has a corresponding semantic concept identifier 420 and information about the semantic concept is stored in the information records 412.

Given a semantic network, such as the semantic network shown in FIG. 4, one or more information records for a semantic concept may be retrieved over the Internet or an Intranet associated with the semantic concept by using a semantic identifier. To retrieve information records, a transformation from a semantic identifier to a request format may be performed. For example, a semantic concept identifier, such as: “Com.MEMOMICS.ALITORA.Company.2002” may be transformed to an Internet (or Intranet) request, such as a URL (uniform resource locator) or URI (uniform resource identifier), via a software component.

An example resulting URL from the example semantic concept identifier may be:

http://MEMOMICS.com/meme/ALITORA/Company/2002.

This Internet request may be used to retrieve information records which may then be displayed via a user interface, or used otherwise. In the above example, this semantic concept identifier may be used to retrieve records for the semantic concept “ORACLE.” To provide for lookup using the request, a server to service the requests may translate the requests to a format understood by the server to identify a corresponding semantic concept. For example, a server at the domain name MEMOMICS.com may understand that all HTTP requests with the folder “meme” are for semantic concepts in a semantic network and the server may use the remaining components of the folder tree in the URL to generate an appropriate identifier for the semantic concept. For example, the sub-tree ALITORA/Company/2002 may be transformed to an identifier ALITORA.Company.2002 which may be a format of a primary key that may be used to access a semantic concept in a meme table, and information from a record representing the semantic concept with that primary key may be returned as a response to the HTTP request. Advantageously, as the semantic concept identifier is data structure agnostic, an underlying data structure for semantic concepts need not be understood and semantic concepts may be referenced using a platform-independent identifier. Thus, for example, applications implemented in different computing platforms (e.g., with different operating systems) may use a same set of semantic concept identifiers to access a number of semantic concepts that may each belong to semantic networks implemented in various types of data structures, and the applications need not be adapted for the various types of data structures.

With reference to the semantic network shown in FIG. 4, semantic concept identifiers, such as: “Com.MEMOMICS.ALITORA.Company.2002” (“ORACLE”) and “Com.MEMOMICS.ALITORA.Company.2001” (“MICROSOFT”) may be used by a software component to retrieve information records concerning the semantic concepts, including records of the relationships among the semantic concepts. The software component may construct an Internet request (such as in the form of a URL), and retrieves information records, including the relationships among semantic concepts. In the above example, the two semantic concept identifiers may retrieve information records of “ORACLE”, of “MICROSOFT”, and the semantic relationship “competitor of” which connects the semantic concepts “ORACLE” and “MICROSOFT.”

In implementations, information records may be retrieved over the Internet or an Intranet, where the information records are associated with semantic concepts using the semantic concept identifiers discussed above and additional criteria. With reference to the example semantic network shown in FIG. 4, semantic concept identifiers, such as: “Com.MEMOMICS.ALITORA.Company.2002” (“ORACLE”) and “Com.MEMOMICS.ALITORA.Company.1010” (“Commercial Company”), and additional criteria may be used by a software component to retrieve information records concerning the corresponding semantic concepts. The additional criteria may include one or more types of data, such as:
data in information records associated with a semantic concept (e.g., fielded data, such as text strings, date ranges, numerical ranges, monetary ranges, and the like which may describe properties of a semantic concept),
data associated with the semantic network, such as a distance between two semantic concepts measured in a number of “hops” necessary to reach one from the other using relationships, and
data concerning the structure of the semantic network, such as one or more paths that connect two semantic concepts in the semantic network where a path may include a specific series of semantic concepts which begin at one semantic concept, end at another semantic concept, and are enumerated in series semantic relationships which connect one semantic concept to the next (e.g., a path between ORACLE and Commercial Company may be “ORACLE Is A Software Company and Software Company is a Type Of Commercial Company,” which relates the semantic concepts and relationships across the semantic concepts).

The software component may construct an Internet request (such as in the form of a URL), and retrieve information records. For example, a request seeking the path between the two above semantic concept identifiers ORACLE and Commercial Company may produce information that includes:

“Com.MEMOMICS.ALITORA.Company.2002” (“ORACLE”)

the Relationship “Is A” (“ORACLE”→“Software Company”)

“Com.MEMOMICS.ALITORA.Company.1020” (“Software Company”)

the Relationship “Type Of” (“Software Company”→“Commercial Company”)

“Com.MEMOMICS.ALITORA.Company.1010” (“Commercial Company”)

FIG. 5 includes a UMIS system 500 to respond to a request for data, where the request includes multiple semantic concept identifiers 502, 504 combined with additional criteria 506 used to construct an Internet request 508 (which may, for example, include one or more URLs) to retrieve information records 510. As an example of operation of the system 500, the first semantic concept identifier 502 may be used to generate a list of URLs (e.g., a list of URLs for semantic concepts including the semantic concept identified by the first semantic concept identifier 502 and semantic concepts that are one hop from that semantic concept; e.g., a request for the semantic concept may be performed and the results of that request may be used to build a list of URLs including the related semantic concepts) and URL patterns (e.g., a URL pattern may include a sub-tree structure of a URL that identifies one or more semantic concepts), and the second semantic concept identifier 504 may be used to generate a list of URLs and URL patterns (e.g., similar to use of the first semantic concept identifier). The additional criteria may be used to filter the URLs/URL patterns for matches (e.g., the criteria may be applied, individually, to each set of URLs for each semantic concept identifier; e.g., values of properties of the corresponding semantic concepts may be compared against criteria for the properties), and the set of URLs/URL patterns could be logically combined to produce a union or an interaction (e.g., a service with which a client program may interact to browse results) for a final list of URLs and URL patterns.

For example, the first and second semantic concept identifiers 502, 504 may respectively identify semantic concepts for the FORD and NISSAN car companies, and the additional criteria 506 may be “all two door coupes.” The first semantic concept identifier 502 may be used to generate a URL that, when requested, returns a list of all semantic concepts related to FORD with URLs identifying the location of those semantic concepts, and the second semantic concept identifier 504 may be used to generate a URL that, when requested, returns a list of all semantic concepts related to NISSAN with URLs identifying the location of those semantic concepts. The respective lists may include information about the semantic concepts, including properties of the semantic concepts. The properties of the semantic concepts may be matched against the criteria of “all two door coupes” to find matching semantic concepts for each list. The lists of matching semantic concepts may be combined to provide a list of URLs to identify a total list of all matching semantic concepts, and the URLs in that list of URLs may be used to request information records 510 that may be returned to a requester.

In implementations, information records may be retrieved over the Internet or an Intranet, where the information records are associated with semantic concepts, and the retrieving is done using criteria other than semantic concept identifiers. That criteria may include one or more of the following:
data in information records associated with a semantic concept,
data associated with the semantic network, such as a distance between two semantic concepts measured in a number of “hops” necessary to reach one from the other using relationships, and
data concerning the structure of the semantic network, such as the path which connects two semantic concepts in the semantic network where the path is defined as a specific series of semantic concepts which begin at one semantic concept, end at another semantic concept, and enumerate in series semantic relationships which connect one semantic concept to the next.

FIG. 6 includes a UMIS system 600 that receives requests for information about semantic concepts with criteria 602 other than semantic concept identifiers and uses that criteria 602 to construct an Internet request 604 to retrieve information records 606 including UMIS identifiers for semantic concepts matching the criteria 602. Operation of the system 600 of FIG. 6 may be similar to operation of the system 500 described with reference to FIG. 5, except that instead of using semantic concept identifiers as part of criteria for a request, only criteria other than semantic concept identifiers may be used. Thus, for example, a request including criteria of all NISSAN and FORD two door coupes may be used to find semantic concepts matching that criteria (e.g., the name NISSAN may be part of a name property of a semantic concept and related semantic concepts with a “Type Of” relationship may be searched to find out if they match the criteria of two door coupe). As another example, the criteria may be a date range, such as find all new semantic concepts defined in the past 24 hours; a set of matching fields, such as find all semantic concepts issued by X; and the like.

In implementations, semantic concept identifiers may be embedded in documents, such as documents published on the Internet or an Intranet. A document may be embedded with a semantic concept identifier to associate information in the document with authoritative information concerning the semantic concept.

In implementations, a document may include a UMIS semantic concept identifier as a text string, such as: “Com.MEMOMICS.ALITORA.Company.2002”. If installed in a web browser (e.g., as a plug-in or a component of a web browser), UMIS software may associate text strings found in Internet documents conforming to a UMIS standard (e.g., conforming to the example semantic concept identifier schema discussed above) with an active “clickable” URL.

In implementations, a UMIS semantic concept identifier may be appended to a published URL for UMIS resolution allowing an author of a document to create a “clickable” URL. As an example:

“http://www.MEMOMICS.com/meme/Com.MEMOMICS.ALITORA.Company.2002”

includes both a URL component, “http://www.MEMOMICS.com/meme/,” and a corresponding semantic concept identifier component “Com.MEMOMICS.ALITORA.Company.2002.”

In implementations, an author of a document may include semantic identifiers in accordance with a UMIS schema and a UMIS system (e.g., as an executable code portion of a document) to allow embedded UMIS semantic concept identifiers to be activated by the UMIS system. For example, an HTML (HyperText Markup Language) document may include a JAVASCRIPT implementation of a UMIS system and semantic concept identifiers to be understood by the UMIS system. Following that example, an example function UMISLink( ) may serve as a mechanism to produce a valid URL from a UMIS semantic identifier using a format, such as:

<a href=“Com.MEMOMICS.ALITORA.Company.2002” onClick=“UMISLink(this)”></a>

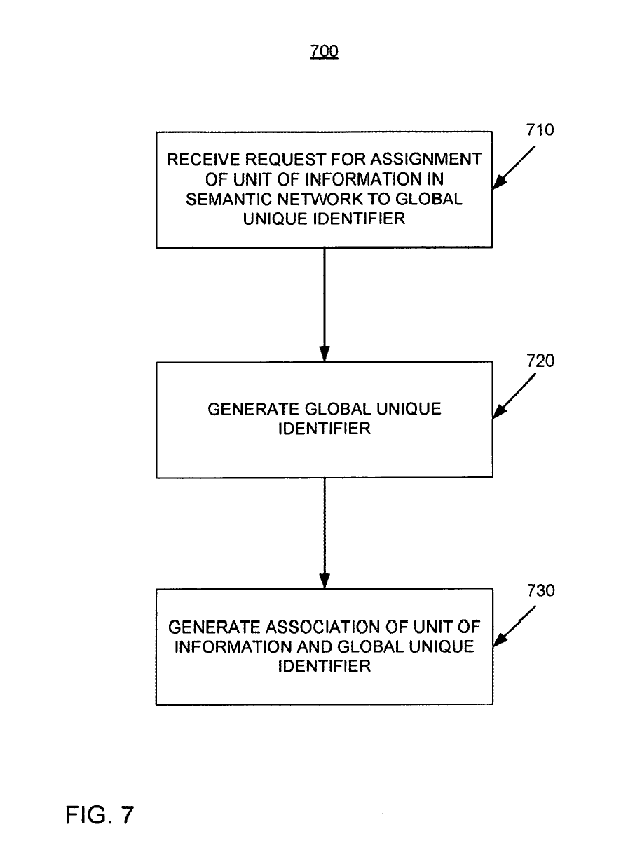

FIG. 7 includes a flowchart of a process 700 to generate global unique identifiers. The global unique identifiers that are generated may be in the format of the semantic concept identifier schema described above or may differ. The process 700 may be carried out by a system, such as the system 200 of FIG. 2. In general, the process 700 includes receiving a request for assignment of a unit of information in a semantic network to a global unique identifier (710), generating the global unique identifier (720), and generating an association of the unit of information and the global unique identifier (730). The unit of information may be a meme, which may be described as being uniquely defined by a combination of a semantic concept (e.g., including information about the semantic concept) and its relationships in a semantic network.

Receiving a request for assignment of a unit of information in a semantic network to a global unique identifier (710) may include, as examples, receiving an application programming interface (API) call to perform the assignment, receiving data characterizing user input requesting assignment of a semantic concept to a global unique identifier, and the like. For example, an application may automatically add semantic concepts to a semantic network as the application digests news articles that are published by the ASSOCIATED PRESS, and, as part of that process, the application may generate an API call to assign a unique identifier to a new semantic concept to be added to the semantic network. The request may be received at a system, such as the system 200 of FIG. 2. The request may be generated from a component of the system to receive the request or from another component, which may be part of another component at a same system or a component at another system. The request may include any type of information, such as the unit of information to be assigned a global unique identifier, information to be used to generate the global unique identifier (e.g., a name of an issuer if an issuer is to be part of a global unique identifier), and the like. The unit of information may have a set of relationships with other units of information that have their own relationships and the relationships of the unit of information in combination with information about the unit of information may uniquely identify the unit of information. A scope of unique identification may be global in the sense that it may be across all semantic networks maintained by a system to maintain the semantic networks.

Generating the global unique identifier (720) may include generating the global unique identifier according to schema, such as the schema described above for semantic concept identifiers. As an example, a schema may define a global unique identifier to include data identifying an authority (e.g., an entity to manage issuers, such as a domain name under which a group of issuers may be managed), data identifying an entity (e.g., a name of an individual person, group of people, computer program, or other entity) of the authority having permission to issue global unique identifiers, data identifying a grouping of global unique identifiers (e.g., a name of a namespace, which may define a scope of names for instance and may group instances according to a relationship; e.g., all instances under a namespace “Companies” may be companies such that the namespace may assist with understanding an instance referred to by a global unique identifier; in implementations there may be sub-namespaces to allow for further levels of grouping), and data identifying the unit of information in the grouping of global unique identifiers (e.g., a pseudo-randomly generated alphanumeric sequence; in implementations there may additional be sub-instances, and an instance-sub-instance relationship may reflect a relationship among an instance and its sub-instances (e.g., a hierarchy or grouping)). Data that identifies an entity, grouping, and the like may be a name or other information from which an entity, grouping, and the like may be identified.

Generating a global unique identifier may include determining whether an authority or issuer is permitted to cause global unique identifiers to be generated (e.g., looking up an authority in a table of authorities, checking a digital signature of an issuer, and the like).

The information used to generate a global unique identifier may come from a variety of sources. For example, a name of an authority and issuer may be derived from a request (e.g., from a sender's domain name). As another example, a namespace may be included in a request, derived from a context (e.g., a namespace for a semantic concept may be derived from a name of a semantic network to which a semantic concept is to be added), and the like. As another example, an instance identifier may be pseudo-randomly generated such that it is unique within a namespace (e.g., pseudo-random numbers may be generated until it is determined that a number is unique within a given namespace).

The global unique identifier may be formatted in a schema that allows for easy transformation, according to an understood standard of transformation, to a request for the unit of information associated with the global unique identifier. For example, as described above, a name of an authority may be based on an Internet domain name and other components of the global unique identifier may be part of a folder tree such that a global unique identifier may be translated to a URL (including that domain name and folder tree) that may be used to request information about the unit of information.

Generating an association of the unit of information and the global unique identifier (730) may include, as examples, storing information for the unit of information in a database record having the global unique identifier as a field of the record, storing an index of global unique identifiers and associated information records for an associated unit of information, and the like.

Generating an association of the unit of information and the global unique identifier may include generating an association between a global unique identifier and an identification of the unit of information in an underlying data structure (e.g., a name of database table for the unit of information and the record identifier). Associations of units of information and global unique identifiers may be stored in a data structure, such as a database, that may be used to find the unit of information based on a global unique identifier. For example, a program may use global unique identifiers to reference semantic concepts. That program may retrieve information for a specific global unique identifier using a system, such as the UMIS system 200 of FIG. 2. The system may find the location of information defining the semantic concept based on a lookup of associations between global unique identifiers and semantic concepts, and return that information to the program.

Although the process 700 includes a certain number and type of sub-processes, implementations may vary. For example, an association of the unit of the information and the global unique identifier may be stored in a database. As another example, the global unique identifier may be used to dictate identification of the unit of information in a data structure (e.g., the global unique identifier may be a primary key to a record including information about the unit of information).

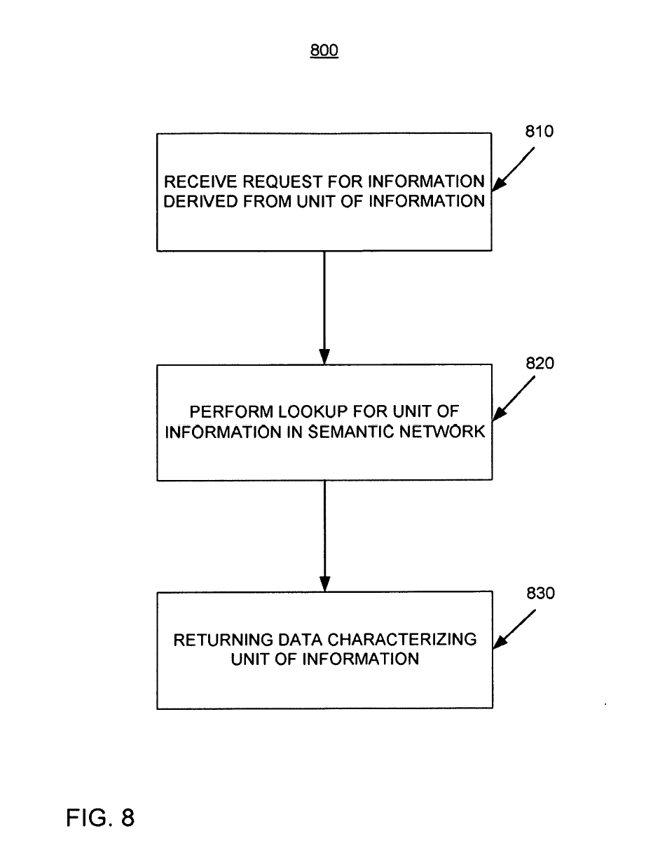

FIG. 8 includes a flowchart of a process 800 to retrieve information about memes. The process 800 may be carried out by a system, such as the system 200 of FIG. 2. The unit of information described with reference to the process 800 of FIG. 8 may be the same as a unit of information described with reference to the process 700 of FIG. 7 (e.g., a meme). In general, the process 800 includes receiving a request for information derived from a unit of information (810), performing a lookup for the unit of information in a semantic network (820), and returning data characterizing the unit of information (830).

Receiving a request for information derived from a unit of information (810) may include, as an example, receiving an API call. The request may include a global unique identifier of a unit of information, criteria to use to find one or more units of information, or a combination of types of information. The unit of information may have a set of relationships with other units of information that have their own relationships, where the relationships of the unit of information in combination with information about the unit of information may uniquely identify the unit of information. Information about the unit of information may include temporal information (e.g., a time of generation of a semantic concept instance), a name of the unit of information (e.g., the name Software Company for the software company semantic concept described above with reference to FIG. 4), a point of origin (e.g., an identification of an authority and issuer that generated the semantic concept), and the like.

Performing a lookup for the unit of information in a semantic network (820) may include transforming a global unique identifier to a format that may be used to find information about a unit of information in an underlying data structure. For example, a global unique identifier may be transformed to a primary key for use in a database. As another example, a global unique identifier may be transformed to a URL for an HTTP request.

Returning data characterizing the unit of information (830) may include returning a name of a unit of information, returning relationships of the unit of information, returning hop lists of a unit of information, or other information that may be derived from a unit of information that has relationships (e.g., any information that may be included in records for memes). The returning may include generating a response with the data and causing the response to be transmitted to the party that made the request of the sub-process 810.

Although the drawings include a certain number and type of components, and the descriptions have been described in certain ways, implementations may vary. For example, instead of performing an internet request, another type of request, such as an intranet request may be performed. As another example, the transformation process need not be part of the systems 200, 500, 600 of FIGS. 2, 5, and 6. As another example, a system may perform association of unique identifiers with semantic concepts, and that system may include a software component to manage the association and a database to store a semantic network with associations of semantic concepts and unique identifiers. As another example, although retrieval of information for a semantic concept is defined as being over an internet or intranet, other types of architectures may be used to handle requests for information about semantic concepts in a semantic network. As another example, although one schema, for semantic concept identifiers, with a certain combination of features is described, the schema may vary. For example, the schema may have additional components, such as sub-instances or sub-issuers. As another example, an order of components of the components may differ.

Some or all of the functional operations described in this description may be implemented in digital electronic circuitry, or in computer software, firmware, or hardware, including the structures disclosed in this specification and their structural equivalents, or in combinations of them. The subject matter may be implemented as one or more computer program products, i.e., one or more modules of computer program instructions encoded on a computer readable medium, e.g., a machine readable storage device, a machine readable storage medium, or a memory device, for execution by, or to control the operation of, data processing apparatus.

The term “data processing apparatus” may include all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

An electronic document may be a data structure containing structured or unstructured information, and an electronic document may be represented by one or more files. An electronic document may store data, such as word processing data, or other types of document (e.g., sets of drawings, project data, and the like).

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the disclosed subject matter may be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed subject matter may be implemented in a computing system that includes a back end component, e.g., as a data server, or that includes a middleware component, e.g., an application server, or that includes a front end component, e.g., a client computer having a graphical user interface or a web browser through which a user can interact with an implementation of the disclosed subject matter, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Particular implementations of the disclosed subject matter have been described. Other implementations are within the scope of the following claims. For example, the steps recited in the claims can be performed in a different order and still achieve desirable results. In addition, implementations of the disclosed subject matter are not limited to database architectures; for example, a semantic network may be implemented in data structures composed of object oriented programming objects.

What is claimed is:

1. A computer-implemented method comprising:
receiving a request for information derived from a unit of information, the unit of information having a set of relationships with other units of information that have their own relationships, the relationships of the unit of information in combination with information about the unit of information uniquely identifying the unit of information within a namespace of units of information, the request comprising a unique identifier to uniquely identify the unit of information;
performing a lookup for the unit of information in a semantic network, the unit of information being associated with the unique identifier; and
returning data characterizing the unit of information.

2. The method of claim 1, wherein the performing the lookup comprises generating a network request based on the unique identifier.

3. The method of claim 1, wherein the generating the network request comprises generating a uniform resource locator based on the unique identifier.

4. The method of claim 1, wherein the semantic network is a directed graph consisting of vertices, which represent concepts, and edges, which represent semantic relations between the concepts.

5. The method of claim 1, wherein the unit of information is a meme.

6. The method of claim 1, wherein the global unique identifier comprises:
data identifying an authority,
data identifying an entity having permission by the authority to issue global unique identifiers,
data identifying a grouping of global unique identifiers, and
data identifying the unit of information in the grouping of global unique identifiers.

7. The method of claim 1, wherein the information about the unit of information is a name of the unit of information.

8. The method of claim 1, wherein the semantic network is represented in a database having records, each record comprising fields characterizing one or more relationships among units of information in the semantic network.

9. A computer-implemented method comprising:
receiving a request for assignment of a unit of information to a global unique identifier, the unit of information having a set of relationships with other units of information that have their own relationships and the relationships of the unit of information in combination with information about the unit of information to uniquely identify the unit of information within a namespace of units of information;
generating the global unique identifier, the global unique identifier comprising:
data identifying an authority,
data identifying an entity having permission by the authority to issue global unique identifiers,
data identifying a grouping of global unique identifiers, and
data identifying the unit of information in the grouping of global unique identifiers; and
generating an association of the unit of information and the global unique identifier.

10. The method of claim 9, wherein the global unique identifier is used to query a semantic network.

11. The method of claim 9, wherein the semantic network is a directed graph consisting of vertices, which represent concepts, and edges, which represent semantic relations between the concepts.

12. The method of claim 9, wherein the unit of information is a meme.

13. A computer-implemented database comprising:
a semantic network, the semantic network defined by units of information and their relationships with other units of information; and
global unique identifiers associated with the units of information.

14. The database of claim 13, wherein the semantic network is a directed graph consisting of vertices, which represent concepts, and edges, which represent semantic relations between the concepts.

15. The database of claim 13, wherein the units of information are memes.

16. A computer-implemented data structure recorded on computer-readable media, the data structure comprising:
associations of global unique identifiers and semantic concepts of a semantic network, the associations having a one to one cardinality between the global unique identifiers and the semantic concepts, the associations to identify locations of data representing the semantic concepts based on global unique identifiers, the global unique identifiers being globally unique within the semantic network.

17. The data structure of claim 16, wherein the global unique identifiers are globally unique across a plurality of semantic networks.

18. A computer-implemented electronic document recorded on computer-readable media, the electronic document comprising a global unique identifier of a semantic concept of a semantic network, the semantic concept represented by a unit of information and the global unique identifier comprising:
data identifying an authority,
data identifying an entity having permission by the authority to issue global unique identifiers,
data identifying a grouping of units of information in the semantic network, and
data identifying the unit of information in the grouping.

19. The electronic document of claim 18, wherein components of the global unique identifier are in an order from a first component to a last component of the data identifying the authority, the data identifying the entity having permission by the authority, the data identifying the grouping of units of information, and the data identifying the unit of information.
